(19) United States
(12) Patent Application Publication
(10) Pub. No.: US 2008/0148504 A1
(43) Pub. Date: Jun. 26, 2008

(54) Hair Brush with Absorbing Device for Hair Conditioning Oil

(76) Inventor: Lio Kuo, Taipei City (KR)

Correspondence Address: RABIN & Berdo, PC, 1101 14TH STREET, NW, SUITE 500, WASHINGTON, DC, 20005, US

(21) Appl. No.: 11/613,350

(22) Filed: Dec. 20, 2006

(51) Int. Cl. B08B 1/00; A46B 9/02; A45D 24/00; A45D 44/18

(52) U.S. Cl. 15/104.94; 15/104.93; 15/160; 132/219; 401/138

(57) ABSTRACT

A hair brush with hair conditioning oil absorbing device on brush bristles embedding part; the hair conditioning oil absorbing device of the hair brush adopts multiple separate granules or lumps design, and there is a space between each pouring body of the hair conditioning oil absorbing device; since the space is part of the hair brush, strength of brush will not be affected; furthermore, brush bristles can be placed on the spaces; therefore, distribution of brush bristles will not be affected by locations of hair conditioning oil absorbing devices and it will not create a big area without brush bristles in the center to damage its hair-combing function.

### BACKGROUND OF THE INVENTION

1) Field of the Invention

The present invention herein relates to a hair brush with hair conditioning oil absorbing device, and after adding hair conditioning oil into the absorbing device, user can apply hair conditioning oil on hair directly when combing hair.

2) Description of the Prior Art

Smear conditioning oil or wax on hair as usual. Most of the methods for polishing hair are digging conditioning oil or hair wax with fingers directly, rubbing evenly on palms, and then smearing oil or wax on hair by palms. The disadvantage of this process is that palms will be contaminated with oil or wax. Someone has worked for improving this problem, e.g. U.S. Pat. No. 5483,719. This patent can also apply conditioning oil or hair wax on hair by pouring or applying conditioning oil or hair wax onto absorbing device on hair brush in advance, but its disadvantages are as follows: 1) Long-strip-shaped pouring body B occupies too much space and creates a big concave area A without brush bristles (as FIG. 1), hence hair-combing process will be inefficient. 2) The second and the third preferred embodiment of this patent are equipped net or whole piece aperture pouring piece, and this could decrease or damage strength of the brush, moreover, conditioning oil or hair wax will contaminate edge of the brush. Therefore, products related to the second and the third preferred embodiment of the patent have yet to be placed on market.

Hence, how to efficiently eliminate disadvantages of the US patent will be the major issue of the present invention.

### SUMMARY OF THE INVENTION

The objective of the present invention herein is to provide a practical hair brush equipped with hair conditioning oil absorbing device, especially for improving U.S. Pat. No. 5,483,719.

In the present invention, hair conditioning oil absorbing device of the hair brush will exclude traditional long-strip-shaped or net or whole piece aperture design, but adopt multiple separate granules or lumps design. A space is designed between each pouring body of the hair conditioning oil absorbing device, and the space is part of the brush, hence brush bristles can be placed on it.

In the present invention, hair conditioning oil absorbing device of the hair brush adopts multiple separate granules or lumps design, and the space between each pouring body of the hair conditioning oil absorbing device is part of the hair brush. Hence, strength of hair brush is improved and will not be damaged easily.

In the present invention, hair conditioning oil absorbing device of the hair brush adopts multiple separate granules or lumps design, and brush bristles can be placed on the space between each pouring body of the hair conditioning oil absorbing device. Therefore, distribution of brush bristles will not be affected by locations of hair conditioning oil pouring body, and definitely there will not be a big bristle-free area A created at the center of brush bristles area to damage functions of the hair brush.

### BRIEF DESCRIPTION OF THE DRAWINGS

Other features and advantages of the present invention will become apparent in the following detailed description of the preferred embodiments, with reference to the accompanying drawings, in which:

FIG. 1 is an overlooking schematic view showing a hair brush of the prior art;

FIG. 2 is a perspective view showing a hair brush of an embodiment of the present invention;

FIG. 3 is an overlooking schematic view showing a hair brush of another embodiment of the present invention; and

FIG. 4 is an overlooking schematic view showing a hair brush of a further embodiment of the present invention.

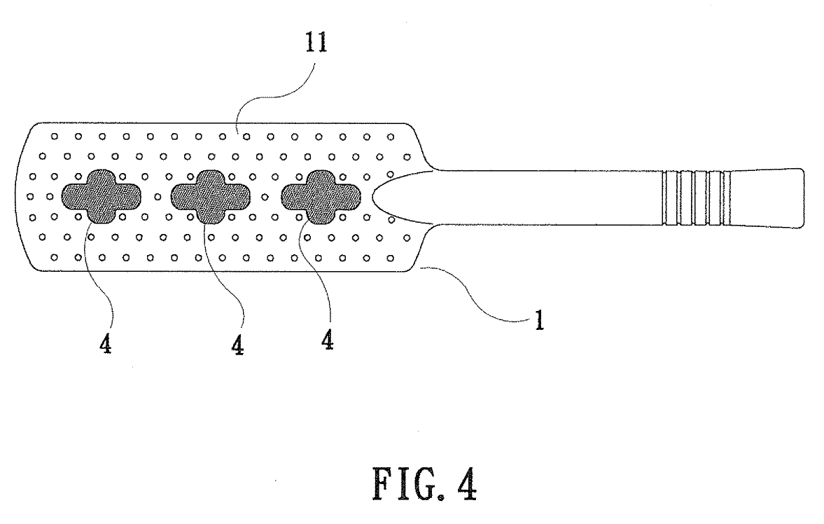

### DETAILED DESCRIPTION OF THE PREFERRED EMBODIMENTS

In the detailed description of the preferred embodiments, it should be noted that like elements are indicated by the same reference numerals throughout the disclosure.

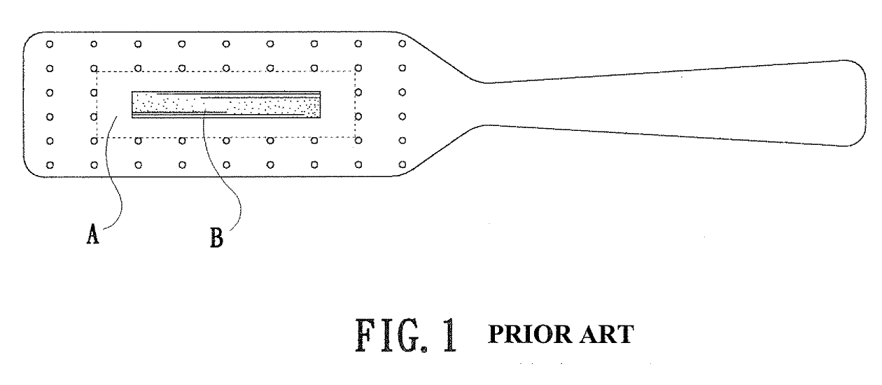

Referring now to FIG. 1, as for the hair brush equipped with hair conditioning oil absorbing device of the present invention, multiple pouring bodies 2 having strong absorbability are inset on the brush bristles embedding part 11 of hair brush 1 to become hair conditioning oil absorbing devices. Pouring body 2 is separate granules or lumps, and there is a space between each pouring body 2 of the hair conditioning oil absorbing device. Moreover the space is part of the hair brush, and brush bristles can be placed on it.

According to the present invention, hair conditioning oil absorbing device of the hair brush 1 adopts multiple separate granules or lumps design, and the space between each pouring body 2 of the hair conditioning oil absorbing device is part of the hair brush 1. Hence, strength of hair brush 1 is improved and will not be damaged easily.

According to the present invention, hair conditioning oil absorbing device of the hair brush 1 adopts multiple separate granules or lumps design, and brush bristles can be placed on the space between each hair conditioning oil absorbing device. Therefore, distribution of brush bristles will not be affected by locations of hair conditioning oil pouring body 2 to damage its hair-combing function. Therefore hair brush 1 can apply hair conditioning oil on hair evenly when combing hair.

According to present invention, multiple pouring bodies 2 for absorbing hair conditioning oil are inset on the brush bristles embedding part 11. When making use of the present invention to comb hair and apply oil, firstly, add or apply hair conditioning oil onto pouring body 2 of the hair conditioning oil absorbing device to make hair conditioning oil absorbed on pouring body 2 of the hair conditioning oil absorbing device; then, when combing hair, pouring body 2 of the hair conditioning oil absorbing device will continuously and smoothly release little hair conditioning oil absorbed on it and the released hair conditioning oil will be applied on hair evenly. Consequently, hair-combing process and oil-applying process can be completed at a time; not only the situation of oily hands contaminated with hair conditioning oil can be avoided, but the phenomena of applying oil unevenly can be also improved efficiently.

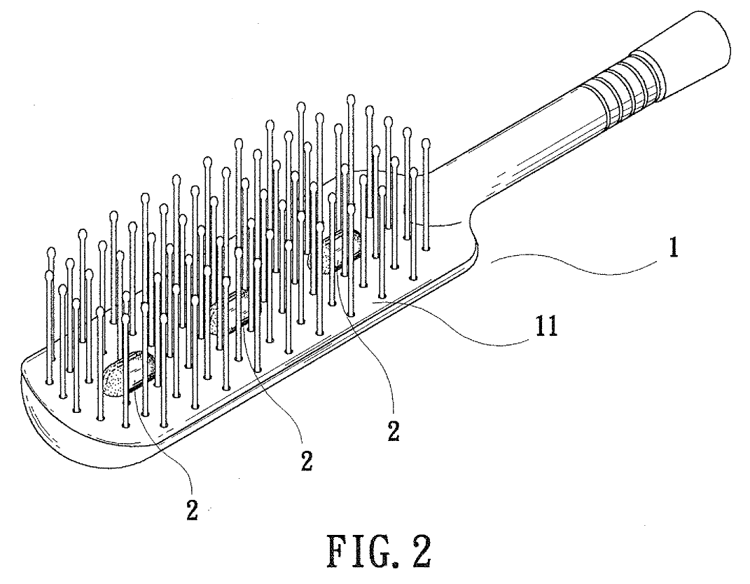

FIG. 2 is an another preferred embodiment diagram of the present invention, and on which settlement of individual pouring body 3 of the hair conditioning oil absorbing device inset on the brush bristles embedding part 11 of hair brush 1 is shown distributed as a slanting strip. Pouring body 3 of the hair conditioning oil absorbing device also adopts separate design; a space is designed between each pouring body of the hair conditioning oil absorbing device, and the space is part of the hair brush and brush bristles can be placed on it; hence strength of hair brush will not be damaged and the distribution of brush bristles will not be decreased to affect hair-combing function.

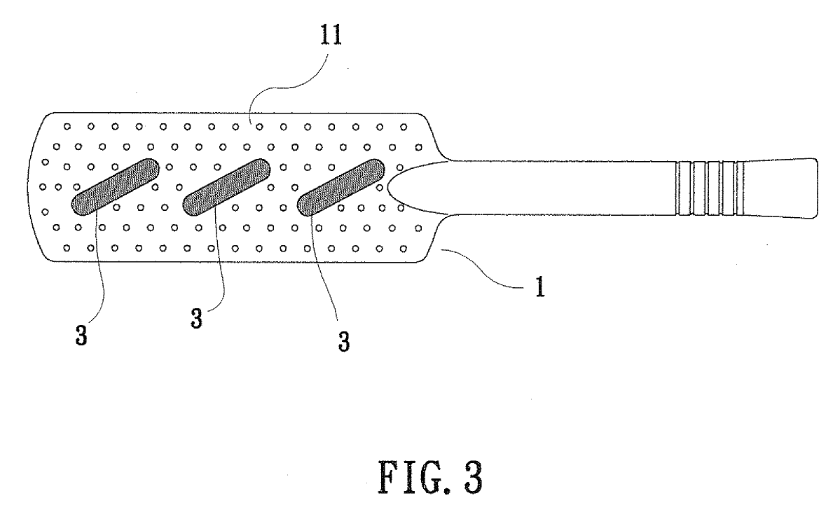

FIG. 3 is a further preferred embodiment diagram of the present invention, and on which settlement of individual pouring body 4 of the hair conditioning oil absorbing device inset on the brush bristles embedding part 11 of hair brush 1 is shown distributed as a bigger area of crisscross shape. Pouring body 4 of the hair conditioning oil absorbing device also adopts separate design; a space is designed between each pouring body of the hair conditioning oil absorbing device, and the space is part of the hair brush and brush bristles can be placed on it; hence strength of hair brush will not be damaged and the distribution of brush bristles will not be decreased to affect hair-combing function.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

What is claimed is:

1. A hair brush with hair conditioning oil absorbing device on brush bristles embedding part in which the hair conditioning oil absorbing device of the hair brush adopts multiple separate granules or lumps design, and there is a space between each pouring body of the hair conditioning oil absorbing device; since the space is part of the hair brush, strength of brush will not be affected; furthermore, brush bristles can be placed on the spaces; therefore, distribution of brush bristles will not be affected by locations of hair conditioning oil absorbing devices and it will not create a big area without brush bristles in the center to damage its hair-combing function.

2. A hair brush with hair conditioning oil absorbing device on brush bristles embedding part according to claim 1 in which the said settlement of individual pouring body of the hair conditioning oil absorbing device is distributed as a slanting strip; each pouring body of the hair conditioning oil absorbing device also adopts separate design; a space is designed between each pouring body of the hair conditioning oil absorbing device, and the space is part of the hair brush and brush bristles can be placed on it.

3. A hair brush with hair conditioning oil absorbing device on brush bristles embedding part according to claim 1 in which the said settlement of individual pouring body of the hair conditioning oil absorbing device is distributed as a bigger area of crisscross shape; each pouring body of the hair conditioning oil absorbing device also adopts separate design; a space is designed between each pouring body of the hair conditioning oil absorbing device, and the space is part of the hair brush and brush bristles can be placed on it.
